(19) United States
(12) Patent Application Publication
(10) Pub. No.: US 2023/0331021 A1
(43) Pub. Date: Oct. 19, 2023

(54) MULTILAYER BODY AND METHOD FOR PRODUCING A MULTILAYER BODY

(71) Applicant: LEONHARD KURZ Stiftung & Co. KG, Fürth (DE)

(72) Inventors: Christian SCHULZ, Fürth (DE); Martina SCHMIDT, Fürth (DE); Violetta OLSZOWKA, Fürth (DE); Marko MAY, Fürth (DE)

(21) Appl. No.: 18/027,416

(22) PCT Filed: Sep. 7, 2021
(86) PCT No.: PCT/EP2021/074615

§ 371 Date: Mar. 21, 2023

(30) Foreign Application Priority Data
Sep. 25, 2020 (DE) 10 2020 125 128.9

(51) Int. Cl. B42D 25/355; B42D 25/369; B42D 25/373; B42D 25/378

(52) U.S. Cl. CPC B42D 25/355; B42D 25/369; B42D 25/373; B42D 25/378

(57) ABSTRACT

A multilayer body (1) as well as a method for producing a multilayer body (1). The multilayer body (1) includes at least one carrier layer (10), at least one color layer (12), at least one metal layer (13) and at least one magnetic varnish layer (14) has, wherein the carrier layer (10), in particular the multilayer body (1), has an upper side (31) and an underside (32), and wherein the layers of the multilayer body (1) are arranged in such a way, in particular in the following order, that
a) the at least one color layer (12), the at least one metal layer (13), and the at least one magnetic varnish layer (14) are applied to the underside (32) of the carrier layer (10); or
b) the at least one metal layer (13) and the at least one color layer (12) are applied to the upper side (31) of the carrier layer (10) and the at least one magnetic varnish layer (14) are applied to the underside (32) of the carrier layer (10).

The invention relates to a multilayer body, in particular security thread, and a method for producing a multilayer body.

It is known to equip security documents, in particular banknotes, with magnetic elements in order to check them for authenticity by machine. A security element which is both visually perceptible by an observer and at the same time suitable for checking by machine is known from WO 9211142 A1. There, the magnetic security thread is surrounded by a metallically reflective layer, with the result that it does not disrupt the overall impression of the data medium or the security document in reflected light. In transmitted light, however, this security thread is to be recognized very markedly.

The object of the invention is now to specify a colored multilayer body which is particularly difficult to reproduce and a method for producing such a multilayer body with magnetic properties.

The object is achieved by a multilayer body, in particular a security thread for protecting security documents, wherein the multilayer body has at least one carrier layer, at least one color layer, at least one metal layer and at least one magnetic varnish layer, wherein the carrier layer, in particular the multilayer body, has an upper side and an underside, and wherein the layers of the multilayer body are arranged in such a way, in particular in the following order, that
a) the at least one color layer, the at least one metal layer and the at least one magnetic varnish layer are applied to the underside of the carrier layer; or
b) the at least one metal layer and the at least one color layer are applied to the upper side of the carrier layer and the at least one magnetic varnish layer are applied to the underside of the carrier layer.

This object is further achieved by a method for producing a multilayer body, in particular according to claims 1 to 40, wherein the following steps are carried out
i) providing at least one carrier layer, having an upper side and an underside,
ii) applying at least one color layer,
iii) applying at least one metal layer,
iv) applying at least one magnetic varnish layer,
wherein the steps are carried out in such a way that the multilayer body has the following structure, in particular in the specified order:
a) the at least one color layer, the at least one metal layer and the at least one magnetic varnish layer are applied to the underside of the carrier layer;
or
b) the at least one metal layer and the at least one color layer are applied to the upper side of the carrier layer and the at least one magnetic varnish layer are applied to the underside of the carrier layer.

It has been shown here that through the method according to the invention for producing a multilayer body and through the multilayer body according to the invention a multilayer body is obtained which is difficult to reproduce and at the same time has a striking optical effect for the observer, as well as the magnetic varnish perceived as disruptive not being visible to the observer at least from one observation direction.

Further advantageous embodiments of the invention are described in the dependent claims.

By upper side is meant a visible side of the multilayer body or the carrier layer. If the multilayer body or the carrier layer is lying on a table, the side visible from above is defined as the upper side and the side which faces the table, thus the side that is not visible, is defined as the underside. It is understood that it is not possible for every layer to be in contact with the upper side or the underside of the carrier layer. The terms upper side and underside therefore serve to determine the relative position of a layer with respect to the carrier view.

In particular, it is provided that in the case of structure a) after step i) the steps are carried out in the order ii), iii), iv) on the underside of the carrier layer provided in step i), or in the case of structure b) after step i) the steps are carried out in the order iii), ii) on the upper side of the carrier layer provided in step i) and step iv) is carried out on the underside of the carrier layer provided in step i).

It is preferably also provided that the multilayer body has at least one first adhesion-promoter layer and/or at least one masking varnish layer, in particular wherein the layers of the multilayer body are arranged in such a way, in particular in the following order, that
a) the at least one adhesion-promoter layer, the at least one color layer, the at least one metal layer, the at least one magnetic varnish layer and the at least one masking varnish layer are applied to the underside of the carrier layer; or
b) the at least one first adhesion-promoter layer, the at least one metal layer and the at least one color layer are applied to the upper side of the carrier layer and the at least one first adhesion-promoter layer, the at least one magnetic varnish layer and the at least one masking varnish layer are applied to the underside of the carrier layer.

It is also possible that the following steps are further carried out
v) applying at least one first adhesion-promoter layer,
and/or
vi) applying at least one masking varnish layer,
wherein the steps are carried out in such a way that the multilayer body has the following structure, in particular in the specified order:
a) the at least one adhesion-promoter layer, the at least one color layer, the at least one metal layer, the at least one magnetic varnish layer and the at least one masking varnish layer are applied to the underside of the carrier layer; or b) the at least one first adhesion-promoter layer, the at least one metal layer and the at least one color layer are applied to the upper side of the carrier layer and the at least one first adhesion-promoter layer, the at least one magnetic varnish layer and the at least one masking varnish layer are applied to the underside of the carrier layer.

Further, it is preferred that in the case of structure a) after step i) the steps are carried out in the order v), ii), iii), iv), vi) on the underside of the carrier layer provided in step i), or in the case of structure b) after step i) the steps are carried out in the order v), iii), ii) on the upper side of the carrier layer provided in step i) and the steps are carried out in the order v), iv), vi) on the underside of the carrier layer provided in step i).

By a carrier layer is preferably meant a single-layered or multilayered film, the one or more layers of which consist in particular of the following materials or combinations: PET (polyethylene terephthalate), PP (polypropylene), PE (polyethylene), PEN (polyethylene naphthalate), PC (polycarbonate), PVC (polyvinyl chloride), Kapton (poly-oxydiphenylene-pyromellitimide) or other polyimides, PLA (polylactide), PMMA (polymethyl methacrylate) or ABS (acrylonitrile butadiene styrene).

In particular, it is provided that the at least one carrier layer has a layer thickness in the range of from 1 μm to 500 μm, preferably in the range of from 6 μm to 23 μm, further preferably in the range of from 6 μm to 16 μm.

The carrier layer itself can have an adhesion-promoter layer, in particular a first adhesion-promoter layer. This adhesion-promoter layer, in particular first adhesion-promoter layer, is applied in the process of carrier production. The layer thickness of the adhesion-promoter layer of a carrier layer supplied by the carrier supplier lies in the range of from 0.1 μm to 5 μm.

An adhesion-promoter layer increases the adhesion between two layers which otherwise would not have sufficient adhesion to each other. For example, this can be the adhesion of the replication layer to the carrier layer. The adhesion-promoter layer preferably consists of polyester, polyacrylate, polymethacrylate, polyurethane, polystyrene, polybutyrate, nitrocellulose, polyvinyl chlorides, ethylene vinyl acetates, copolymers thereof or similar polymers or mixtures thereof. The adhesion-promoter layer can be made thermoplastic, chemically crosslinking, UV-curable, as a hybrid variant (thermoplastic and UV-curable and/or crosslinking in another way), cold glue/primer or self-adhesive adhesion-promoter layer.

In particular, it is provided that the at least one first adhesion-promoter layer has a layer thickness in the range of from 0.01 μm to 30 μm, preferably in the range of from 0.1 μm to 5 μm.

Further, it is preferably provided that in structure a) the at least one second adhesion-promoter layer has a layer thickness in the range of from 0.01 μm to 30 μm, preferably in the range of from 0.1 μm to 5 μm. It is preferably also possible that in structure a) the at least one third adhesion-promoter layer has a layer thickness in the range of from 0.01 μm to 30 μm, preferably in the range of from 0.1 μm to 10 μm.

It is further also preferably provided that in structure b) the at least one second adhesion-promoter layer has a layer thickness in the range of from 0.01 μm to 30 μm, preferably in the range of from 0.1 μm to 10 μm.

In particular, it is provided that in step v) the at least one first adhesion-promoter layer is applied with a layer thickness in the range of from 0.01 μm to 30 μm, preferably in the range of from 0.1 μm to 5 μm.

Further, it is possible that in structure a) at least one second adhesion-promoter layer is arranged, in particular over the whole surface or at least in areas, on the upper side of the at least one carrier layer. It is further preferably provided that in the case of structure a) and in particular after step vi) the following step is further performed:
x) applying at least one second adhesion-promoter layer, in particular over the whole surface or at least in areas, to the upper side of the at least one carrier layer.

For example, it is also provided that in structure a) at least one third adhesion-promoter layer is arranged on the underside of the at least one carrier layer, in particular underneath the at least one masking varnish layer. The third adhesion-promoter layer preferably serves as an adhesion promoter for a further carrier layer. Thus, it is provided for example that in structure a) at least one further carrier layer is arranged on the underside of the at least one carrier layer, in particular underneath the at least one third adhesion-promoter layer. Preferably, the at least one further carrier layer in structure a) has a layer thickness in the range of from 1 μm to 20 μm, in particular in the range of from 5 μm to 12 μm.

It has advantageously been shown that the stability of the multilayer body, in particular security thread, is increased by at least one further carrier layer. In addition, the resistance to mechanical and chemical environmental influences is increased. At the same time this provides advantages both in the case of the processing of the multilayer body and in the case of the long-term resistance as well as the protection against forgery, in particular with respect to chemical attacks. Further, it has advantageously been shown that at least one further carrier layer protects the other layers of the multilayer body, in particular color layer, metal layer, replication layer, magnetic varnish layer, masking varnish layer, fluorescence varnish layer, adhesion-promoter layer and/or corrosion-protection varnish layer, as these are enclosed by or laminated in the carrier layers on both sides.

In particular, it is provided that in the case of structure a) and in particular after step vi) the following step is further performed:
xi) applying at least one third adhesion-promoter layer, in particular over the whole surface or at least in areas, to the underside of the at least one carrier layer, in particular underneath the at least one masking varnish layer.

Further, it is preferably possible that in the case of structure a) and preferably after step vi), further preferably after step xi), the following step is further carried out:
xii) applying at least one further carrier layer to the underside of the at least one carrier layer, in particular underneath the at least one third adhesion-promoter layer.

In particular, it is provided that in structure b) at least one second adhesion-promoter layer is arranged on the upper side of the carrier layer, in particular on top of the at least one color layer, and/or at least one second adhesion-promoter layer is arranged on the underside of the carrier layer, in particular underneath the at least one masking varnish layer.

Further, it is possible that in the case of structure b) after step ii) and/or after step vi) the following step is further performed:
xiv) applying at least one second adhesion-promoter layer, in particular such that the at least one second adhesion-promoter layer is arranged on top of the at least one color layer and/or underneath the at least one masking varnish layer.

Inorganic materials, such as metals, metal oxides, alloys, oxides or silicates, can also serve as an adhesion-promoter layer or be a constituent of such an adhesion-promoter layer.

The adhesion-promoter layer can likewise contain additives based on organic or inorganic substances which achieve the processing properties, for example during the application of a varnish layer in the above method or during use of the security thread or the multilayer body itself, a predetermined effect. The proportion of additives in the adhesion-promoter layer lies in most cases at 0% and 10%, preferably at 0% and 5%, further preferably between 0.01 and 3%.

Furthermore, fillers can also be part of the formulation of an adhesion-promoter layer. This preferably comprises all further materials added to an adhesion-promoter layer, in particular a polymer-based adhesion-promoter layer, such as for example silica, pigments, dyes, tracers, in particular taggants, and/or similar materials. The proportion of fillers in the entire varnish here is in most cases 0% to 80%.

Moreover, adhesion promoters can be formulated such that they are tacky to liquid even after the solvent has been evaporated and or before the full cure. This is advantageous in particular if two substrates are to be connected to each other over large areas of surface, as is usually the case in a laminating process.

The increase in the adhesion between two layers, in particular between carrier and replication layer, can optionally also be achieved by surface-activating processes such as corona or plasma treatment. These can also be used in combination with an adhesion promoter.

By a replication layer is preferably meant here a special, functional layer in which optically variable structures are introduced and/or fixed in particular by means of thermal replication and/or UV replication. In the case of a hybrid replication layer, the latter is for example thermally replicated and then cured by means of radiation, for example by means of UV radiation and/or at least one electron beam. In the case of a UV-curing replication layer, the latter is replicated at room temperature and simultaneously cured by means of radiation, for example by means of UV radiation and/or at least one electron beam. For example, it is possible that the varnish becomes warm during a UV replication.

It is preferably provided that in structure a) at least one replication layer is arranged between the at least one color layer and the at least one metal layer. Furthermore, it is in particular also provided that in structure b) at least one replication layer is arranged between the first adhesion-promoter layer and/or the carrier layer on the upper side of the carrier layer and the metal layer.

It is also possible that in structure a) and/or in structure b) the at least one replication layer has a layer thickness in the range of from 0.1 μm to 30 μm, in particular in the range of from 0.5 μm to 10 μm.

In particular, it is possible that in structure a) and/or in structure b) the at least one replication layer has optically variable structures, in particular diffractive structures and/or refractive structures and/or isotropic matte structures and/or anisotropic matte structures, which are preferably introduced by means of thermal replication and/or UV replication. For the observer, the optically variable structure of the replication layer results in a particularly striking optical effect. At the same time, this also increases the protection against forgeries.

In particular if the replication layer is deposited over the whole surface, the replication layer is not visible to the observer in the areas in which the color layer and/or the metal layer are not provided, in particular in the second areas, as the replication layer is optically erased because of a similar refractive index to the neighboring layer.

In particular, it is possible that in the case of structure a) between steps ii) and iii) the following step is further carried out:
vii) applying at least one replication layer, in particular by means of gravure printing.

In particular, it is also possible that in the case of structure a) and in step vii) optically variable structures, in particular diffractive structures and/or refractive structures and/or isotropic matte structures and/or anisotropic matte structures, are introduced into the at least one replication layer by means of thermal replication and/or UV replication.

In an alternative embodiment, it is provided that in the case of structure b) between steps v) and iv), in particular ii) and iii), the following step is further carried out: xiii) applying at least one replication layer, in particular by means of gravure printing, with the result that the at least one replication layer is applied to the upper side of the at least one carrier layer between the at least one first adhesion-promoter layer and/or the at least one carrier layer and the at least one metal layer.

It is also possible that in the case of structure b) and in step xiii) optically variable structures, in particular diffractive structures and/or refractive structures and/or isotropic matte structures and/or anisotropic matte structures, are introduced into the at least one replication layer by means of thermal replication and/or UV replication.

In particular, it is provided that the at least one replication layer is arranged registration- or register-accurately relative to the at least one color layer.

By registered or register or registration-accurate or register-accurate or registration accuracy or register accuracy is meant a positional accuracy of two or more layers relative to each other. The register accuracy is to range within a predefined tolerance which is to be as small as possible. At the same time, the register accuracy of several elements and/or layers relative to each other is an important feature in order to increase the protection against forgery. The positionally accurate positioning can be effected in particular by means of sensorily, preferably optically, detectable registration marks or register marks. These registration marks or register marks can either represent specific separate elements or areas or layers or themselves be part of the elements or areas or layers to be positioned.

It is possible in particular that the replication layer provides a first item of optical information. It is preferably possible that the first item of optical information has at least one element selected from: a graphically formed outline, a figural representation, an image, an individual image, a pattern, an endless pattern, a motif, a symbol, a logo, a portrait, a grid, an alphanumeric character, a text and/or combinations thereof.

The color layer preferably consists of a combination of at least one binder and/or at least one filler as well as optionally at least one additive. By color layer is preferably meant a special, functional layer which generates in particular a color impression detectable for an observer and/or further preferably is used as a mask layer, in particular as an exposure mask, and/or as an etch resist.

By color is meant in particular a dyeing which, with respect to the transparency and/or the clarity or the scattering power, preferably comprises dyed crystal clear transparent, dyed scattering transparent or also dyed opaque. The color preferably occurs as an intrinsic color of a material and/or is arranged as an additional dyed layer as in front of a layer in the viewing direction, wherein the layer lying underneath it, in particular the metal layer, is in particular modified in terms of its colored appearance for an observer. Here, the color preferably appears optically constant or invariable in terms of its hue and/or its color saturation and/or in terms of its transparency from almost all, in particular from all, observation and/or illumination angles. It is further possible that the color itself is optically variable, wherein the hue and/or the color saturation and/or the transparency of the color changes when the observation and/or illumination angle changes in particular.

The color layer is preferably formed as a glazing color layer, in particular as a transparently or translucently diaphanous color layer. Further preferably, the color layer preferably contains an additive and/or a filler, which preferably absorbs light in the ultraviolet wavelength range, in particular in a wavelength range of between 200 nm and 380 nm. Such UV blockers preferably enhance the function of the color layer as a mask layer. In particular, the UV blockers have no or only a very low absorption in the wavelength range visible to the human eye of from 380 nm to 780 nm, in order in particular not to alter the color impression of the color layer.

By binders is preferably meant polymer-based systems and mixtures thereof, such as for example polyester, polyacrylate, polymethacrylate, polyurethane, polystyrene, polybutyrate, nitrocellulose, polyvinyl chlorides, ethylene vinyl acetates, copolymers thereof or similar polymers.

By additives is preferably meant organic or inorganic substances which achieve the processing properties, for example during the application of a color layer in the above method, in particular in step ii), or during use of the security thread or multilayer body itself, a predetermined effect. For example, a UV blocker (UV=UV radiation=ultraviolet radiation=electromagnetic radiation from the ultraviolet portion of the spectrum of electromagnetic radiation or from one or more partial regions from the ultraviolet portion of the spectrum of electromagnetic radiation) can be an additive.

By fillers is preferably meant all further materials added to a system, in particular a polymer-based system, such as for example silica, pigments, dyes, UV blockers, tracers, in particular taggants, and/or similar materials.

Dyes and/or pigments are preferably suitable as coloring substances of the at least one color layer. Pigments are preferably practically insoluble, in particular insoluble, in the medium in which they are integrated. Dyes preferably dissolve during their use and in particular lose their crystalline and/or particulate structure. Possible classes of dyes are basic dyes, liposoluble dyes or metal complex dyes. Possible classes of pigments are organic and inorganic pigments. Pigments are preferably constructed from a material present in one piece or in particular alternatively have complex structures, for example as a layer structure with a plurality of layers of different materials and/or for example as capsules of different materials, in particular with a core and a shell.

The colors of the at least one color layer are in particular transparent or at least translucent, wherein the transmissivity preferably lies between 5% and 99%, in particular over a partial region of the wavelength range visible to the human eye of from 380 nm to 780 nm, preferably in the range of from 430 nm to 690 nm. In particular, optically variable effects of the optically variable structures which are arranged underneath the at least one color layer from the observer's direction of view and which are introduced in particular into the at least one replication layer are detectable.

Further, it is possible that the at least one color layer is formed and/or consists of several different colors, wherein here these preferably also have areas with color mixing of the first and second color, which form by means of overlapping of the color layers and/or by halftoning of the color layers. In particular, the color saturation in the color layers varies.

The color layer can be generated with at least one pigment or one colorant with the color cyan, magenta, yellow or black (CMYK=Cyan Magenta Yellow Key: black as color depth) or with the color red, green or blue (RGB) in particular to generate a subtractive mixed color.

As an alternative to the mixed color, pigments or dyes which generate a special, in particular pre-mixed, spot color or color from a special color system (e.g. RAL, HKS, Pantone), for example orange or purple, can also be used.

In particular, it is provided that the at least one color layer has a layer thickness in the range of from 0.1 μm to 30 μm, preferably in the range of from 0.1 μm to 5 μm.

It is further also preferably possible that in step ii) the at least one color layer is applied with a layer thickness in the range of from 0.1 μm to 30 μm, preferably in the range of from 0.1 μm to 5 μm.

The color can be generated directly by thermochromic components. The thermochromic substance can additionally be added to the coloring pigments or dyes of the varnish and thus form a mixed color.

In particular, it is possible that the at least one color layer is arranged in the decoration, preferably is arranged register-accurately or registration-accurately relative to the at least one replication layer. It is preferably also provided that in step ii) the at least one color layer is applied in the decoration, in particular is applied registration-accurately or register-accurately relative to the at least one replication layer.

It is preferably possible that the at least one color layer arranged in the decoration provides a second item of optical information. It is preferably possible that the second item of optical information has at least one element selected from: a graphically formed outline, a figural representation, an image, an individual image, a pattern, an endless pattern, a motif, a symbol, a logo, a portrait, a grid, an alphanumeric character, a text and/or combinations thereof.

It is advantageously provided that the at least one color layer is provided in a first area and is not provided in a second area. It is also possible that in step ii) the at least one color layer is applied in a first area and is not applied in a second area.

It is further also possible that the at least one color layer is designed as an etch resist for structuring the at least one metal layer and/or as an exposure mask for structuring an etch resist.

It is preferably provided that in step ii) the at least one color layer is designed as an etch resist for structuring the at least one metal layer and/or as an exposure mask for structuring an etch resist. In particular if the color layer acts as an exposure mask, a photosensitive layer is applied to the at least one metal layer during the production of the multilayer body or the security thread. The photosensitive layer preferably comprises a photoresist. This photosensitive layer is structured by exposure through the color layer in such a way that the photosensitive layer is easy to remove from the metal layer by solvent in the exposed areas. Then, by means of etching, the metal layer is structured in exact register with the photosensitive layer or the color layer, wherein the photosensitive layer serves as an etch resist. After the etching process, the photosensitive layer can be removed again, with the result that it is no longer present in the structure of the multilayer body. Alternatively, the photosensitive layer can remain in the structure of the multilayer body.

However, it is also possible that the color layer itself serves as an etch resist. In this case, the color layer is applied directly to the metal layer. During the subsequent etching, the metal layer is then structured in exact register with the color layer.

Further, it is possible that the at least one color layer comprises one or more color layers and/or a thin-film layer system and/or effect pigments and/or an optically variable element for dyeing the metal layer. It is preferably provided that in step ii) the at least one color layer is formed of one or more color layers and/or a thin-film layer system and/or effect pigments and/or an optically variable element for dyeing the metal layer.

It is possible that the layers of the multilayer body, in particular of the security thread, have organic UV absorbers, in particular benzotriazole derivatives, with a mass percentage in a range of from approx. 3% to 5%, in particular if the material of the layers does not contain a sufficient quantity of UV-absorbing constituents, such as for example UV-absorbing pigments or UV-absorbing dyes. Suitable organic UV absorbers are sold under the trade name Tinuvin® by BASF.

A photosensitive layer, the solubility of which in particular changes when activated by exposure to light, is preferably used to structure the at least one metal layer, in particular in structure a).

In particular, a photosensitive layer is characterized in that, when sufficiently exposed to light with a suitable wavelength, such as for example by means of UV radiation, this layer becomes soluble in a particular solvent, for example in acidic or basic aqueous solutions, in the exposed areas.

A photosensitive layer preferably comprises for example condensation polymer of m- and p-cresol and formaldehyde (novolac resin), diazonaphthoquinone derivative (DNQ) and solvent or solvent mixture, such as for example 1-methoxy-2-propyl acetate.

In particular, it is provided that in the case of structure a) after step iii) and before step iv), in particular before step viii), the following step is further performed:
xvi) applying at least one photosensitive layer over the whole surface, in particular with the result that the photosensitive layer is applied underneath the at least one metal layer.

It is further also preferably provided that in structure a) after step xvi) the following step is further performed:
xvii) exposing the at least one photosensitive layer to light from the upper side of the multilayer body, with the result that the at least one colored varnish layer serves as an exposure mask for the at least one photosensitive layer and the at least one photosensitive layer is activated by radiation, in particular UV radiation, with the result that the at least one photosensitive layer becomes soluble in a particular solvent, in particular acidic or basic solutions, in the second areas.

It is advantageously possible that in structure a) after step xvii) the following step is further performed:
xviii) structuring the at least one photosensitive layer by means of a solvent, in particular an acidic or basic solution, with the result that the at least one photosensitive layer is removed in the second areas and is preserved in the first areas.

In particular, it is provided that in structure a) after step xviii) the following step is further performed:
xix) demetallizing the at least one metal layer by means of etching, wherein the at least one photosensitive layer serves as an etch resist and the at least one metal layer is removed in the second areas and is preserved in the first areas, in particular with the result that the metal layer is demetallized in exact register with the at least one color layer.

It is preferably possible that in structure a) after step xix) the following step is further performed:
xx) removing the at least one photosensitive layer

In an embodiment variant it is possible that in structure b) after step ii) the following step is further performed:
xxi) demetallizing the at least one metal layer by means of etching, wherein the at least one color layer serves as an etch resist and the at least one metal layer is removed in the second areas and is preserved in the first areas, in particular with the result that the metal layer is demetallized in exact register with the at least one color layer.

In particular, it is provided that the at least one metal layer comprises a material or a combination of materials selected from: aluminum, silver, chromium, copper, tin, gold, zinc or an alloy of the above-named metals. It is further also possible that the at least one metal layer comprises a material selected from: blackened aluminum, in particular substoichiometric AlₓO_{y}, or oxidized silver. The metal layer can be merely partially metallized or also fully metallized.

In particular, it is possible that the at least one metal layer is arranged register-accurately or registration-accurately, in particular in exact register, relative to the at least one color layer. It is also possible that the application of the at least one metal layer in step iii) is effected register-accurately or registration-accurately, in particular in exact register, relative to the at least one color layer.

Furthermore, it is possible that the at least one metal layer is provided in a first area and is not provided in a second area. It is advantageously provided that in step iii) the at least one metal layer is applied in a first area and is not applied in a second area. It is further also possible that in step iii) the at least one metal layer is applied over the whole surface. For this case, it is provided in particular that the metal layer applied over the whole surface is structured or demetallized, in particular by means of etching.

It is possible that in step iii) the at least one metal layer is applied by means of vapor deposition and/or sputtering.

The at least one metal layer is advantageously transparent or semi-transparent or opaque or translucent.

The metal layer can act as a metallic mirror layer or as a semi-transparent absorber layer. The layer thickness of such a metal layer preferably lies between 1 nm and 500 nm, further preferably between 5 nm and 100 nm. This layer can typically serve as a metallic mirror layer from a layer thickness of approx. 15 nm. In the case of a layer thickness smaller than 15 nm this layer can act as a semi-transparent absorber layer. It is also possible that such a layer is formed by application of varnishes containing metal pigments, wherein the layer thickness lies in particular between 0.1 μm and 50 μm, preferably from 1 μm to 20 μm.

In particular, it is provided that the at least one magnetic varnish layer has a layer thickness in the range of from 0.1 μm to 25 μm, preferably in the range of from 0.5 μm to 17 μm.

It is preferably possible that the at least one magnetic varnish layer is applied in the decoration or over the whole surface. Further, it is possible that in step iv) the at least one magnetic varnish layer is applied in the decoration or over the whole surface.

It is advantageously possible that in step iv) the at least one magnetic varnish layer is applied by means of pad printing and/or offset printing and/or digital printing and/or inkjet printing and/or xerographic printing and/or flexographic printing and/or dye-sublimation printing and/or thermal-transfer printing and/or gravure printing and/or slot die and/or screen printing.

In particular, it is possible that the at least one magnetic varnish layer is arranged register-accurately or registration-accurately relative to the at least one color layer and/or the at least one metal layer. It is furthermore also possible that in step iv) the at least one magnetic varnish layer is applied register-accurately or registration-accurately relative to the at least one color layer and/or the at least one metal layer. The register- or registration-accurate application of the magnetic varnish layer guarantees that when the upper side of the multilayer body is viewed the magnetic varnish layer is not visible to the observer and it is covered by the color layer and/or the metal layer.

Further, it is also possible that the at least one magnetic varnish layer is provided in a partial area of the first area and is not provided in a second area, with the result that for an observer viewing the upper side of the multilayer body the at least one magnetic varnish layer is covered by the at least one color layer and/or the at least one metal layer. It is preferably provided that in step iv) the at least one magnetic varnish layer is applied in a partial area of the first area and is not applied in a second area, with the result that for an observer viewing the upper side of the multilayer body the at least one magnetic varnish layer is covered by the at least one color layer and/or the at least one metal layer.

The magnetic varnish layer consists of different components. Ferrimagnetic ceramic substances are used for this. These can have different properties and strengths depending on the use. Ferrites are particularly used. These can have different compositions. The main constituents are in particular hematite (Fe₂O₃) and magnetite (Fe₃O₄) as well as further metal oxides. Further constituents can be nickel (Ni), zinc (Zn), manganese (Mn), cobalt (Co), copper (Cu), magnesium (Mg), cadmium (Cd), barium (Ba) and/or strontium (Sr). The proportion of the magnetic component in the magnetic varnish layer lies between 20% and 80%, preferably between 30% and 50%.

Furthermore, a binder is needed. In addition, additives and fillers can be present.

By binders is preferably meant polymer-based systems and mixtures thereof, such as for example polyester, polyacrylate, polymethacrylate, polyurethane, polystyrene, polybutyrate, nitrocellulose, polyvinyl chlorides, ethylene vinyl acetates, copolymers thereof or similar polymers. It is advantageous if the proportion of the binder in the magnetic varnish layer is between 3% and 50%, preferably between 5% and 30%, further preferably between 7% and 20%.

By additives is preferably meant organic or inorganic substances which achieve the processing properties, for example during the application of a varnish layer in the above method or during use of the security element itself, a predetermined effect. The proportion of additives in the magnetic varnish layer lies in most cases at 0% and 10%, preferably at 0% and 5%, further preferably between 0.01% and 3%.

By fillers is preferably meant all further materials added to a system, in particular a polymer-based system, such as for example silica, pigments, dyes, tracers, in particular taggants, and/or similar materials. The proportion of fillers in the magnetic varnish layer is in most cases 0% to 40%.

In most cases a protective layer against corrosion is applied between the magnetic varnish layer and the metal layer. This is necessary in particular if e.g. aluminum is used as metal layer and there would be direct contact with the magnetic varnish layer.

This protective layer represents a barrier between the metal layer and the magnetic varnish layer and consists of different components.

This corrosion-protection varnish layer preferably consists of one or more binders and one or more additives and fillers.

By binders is preferably meant polymer-based systems and mixtures thereof, such as for example polyester, polyacrylate, polymethacrylate, polyurethane, polystyrene, polybutyrate, nitrocellulose, polyvinyl chlorides, ethylene vinyl acetates, copolymers thereof or similar polymers. It is advantageous if the proportion of the binder in the corrosion-protection varnish layer is between 3% and 50%, preferably between 5% and 30%, further preferably between 7% and 25%.

By additives is preferably meant organic or inorganic substances which achieve the processing properties, for example during the application of a varnish layer in the above method or during use of the security element itself, a predetermined effect. The proportion of additives in the corrosion-protection varnish layer lies in most cases at 0% and 10%, preferably at 0% and 5%, further preferably between 0.01 and 3%.

By fillers is preferably meant all further materials added to a system, in particular a polymer-based system, such as for example silica, pigments, dyes, tracers, in particular taggants, and/or similar materials. The proportion of fillers in the corrosion-protection varnish layer here is in most cases 0% to 80%.

In particular, it is provided that in structure a) at least one corrosion-protection varnish layer is arranged, in particular over the whole surface or at least in areas, between the at least one metal layer and the at least one magnetic varnish layer. It is further also possible that in the case of structure a) between steps iii) and iv) the following step is further carried out:
viii) applying at least one corrosion-protection varnish layer, in particular over the whole surface or at least in areas, in order to prevent a direct contact of the at least magnetic varnish layer with the at least one metal layer.

It is also possible that in structure a) the corrosion-protection varnish layer has a layer thickness in the range of from 0.1 μm to 30 μm, preferably in the range of from 0.1 μm to 5 μm.

In most cases a masking varnish layer is used in order to conceal the in most cases dark magnetic varnish layer from the observer even when viewing the underside of the multilayer body. A colored varnish can be used as masking varnish layer. In particular, it is provided that in step vi) the at least one masking varnish layer is applied by means of pad printing and/or offset printing and/or digital printing and/or inkjet printing and/or xerographic printing and/or flexographic printing and/or dye-sublimation printing and/or thermal-transfer printing and/or gravure printing and/or slot die and/or screen printing.

It is advantageously provided that the at least one masking varnish layer is arranged registration-accurately or register-accurately relative to the at least one magnetic varnish layer, with the result that the at least one masking varnish layer covers the at least one magnetic varnish layer. Further, it is preferably provided that in step vi) the at least one masking varnish layer is applied registration-accurately or register-accurately relative to the at least one magnetic varnish layer, with the result that the at least one masking varnish layer covers the at least one magnetic varnish layer.

Further, it is possible that the at least one masking varnish layer is provided in a first area and is not provided in a second area. In particular, it is possible that in step vi) the at least one masking varnish layer is applied in a first area and is not applied in a second area. However, it is also possible that the at least one masking varnish layer is applied or is provided in the decoration or also over the whole surface.

It is preferably possible that the at least one masking varnish layer has a layer thickness in the range of from 0.1 μm to 50 μm, preferably in the range of from 0.5 μm to 25 μm, further preferably in the range of from 0.1 μm to 5 μm.

The masking varnish layer preferably consists of one or more binders and one or more additives and one or more fillers.

By binders is preferably meant polymer-based systems and mixtures thereof, such as for example polyester, polyacrylate, polymethacrylate, polyurethane, polystyrene, polybutyrate, nitrocellulose, polyvinyl chlorides, ethylene vinyl acetates, copolymers thereof or similar polymers. It is advantageous if the proportion of the binder in the masking varnish layer is between 3% and 50%, preferably between 5% and 30%, further preferably between 7% and 25%.

By additives is preferably meant organic or inorganic substances which achieve the processing properties, for example during the application of a varnish layer in the above method or during use of the security element itself, a predetermined effect. The proportion of additives in the masking varnish layer lies in most cases at 0% and 10%, preferably at 0% and 5%, further preferably between 0.01 and 3%.

By fillers is preferably meant all further materials added to a system, in particular a polymer-based system, such as for example silica, pigments, dyes, UV blockers (UV=UV radiation=ultraviolet radiation=electromagnetic radiation from the ultraviolet portion of the spectrum of electromagnetic radiation or from one or more partial regions from the ultraviolet portion of the spectrum of electromagnetic radiation), tracers, in particular taggants, and/or similar materials. The proportion of fillers in the masking varnish layer here is in most cases 0.01% to 80%, in particular between 0.1% and 25%.

Dyes and/or pigments are preferably suitable as coloring substances of the masking varnish layer. Pigments are preferably practically insoluble, in particular insoluble, in the medium in which they are integrated. Dyes preferably dissolve during their use and in particular lose their crystalline and/or particulate structure. Possible classes of dyes are basic dyes, liposoluble dyes or metal complex dyes. Possible classes of pigments are organic and inorganic pigments. Pigments are preferably constructed from a material present in one piece or in particular alternatively have complex structures, for example as a layer structure with a plurality of layers of different materials and/or for example as capsules of different materials, in particular with a core and a shell. In particular, aluminum pigments are used here as coloring substances. The proportion of coloring substances in the masking varnish layer lies in most cases between 0.01 and 80%, in particular between 0.1 and 35%.

Instead of a masking varnish, a further metal layer can also be vapor-deposited or sputtered, which likewise fulfills a masking function and thus conceals the underlying layers, in particular the magnetic varnish layer. For this, metals such as Al, Ag, Au, Cu, Cr, alloys or also oxides or mixed oxides can be used. These are applied by means of vacuum evaporation, sputtering, CVD, PVD or using a varnish.

Further, it is conceivable to use, behind the masking varnish, a fluorescence varnish which has fluorescent and/or luminescent substances which are excited in particular by means of UV radiation and/or IR radiation. It is hereby made possible in particular that visible light is coupled out of the at least one replication layer in the case of irradiation with UV radiation and/or IR radiation.

In particular, it is provided that in structure a) at least one fluorescence varnish layer is arranged, in particular over the whole surface or at least in areas, on the underside of the carrier layer, in particular underneath the at least one masking varnish layer. Further, it is preferably possible that in the case of structure a) after step vi) the following step is further performed:
ix) applying at least one fluorescence varnish layer, wherein the at least one fluorescence varnish layer is applied to the underside of the at least one masking varnish layer.

It is further preferably provided that in structure a) the fluorescence varnish layer has a layer thickness in the range of from 0.1 μm to 10 μm, preferably in the range of from 0.1 μm to 2 μm.

The fluorescent substances in the fluorescence varnish layer are preferably perylene dyes, such as for example Lumogen F types, in particular Lumogen F Red 305, Lumogen F Yellow 170, Lumogen F Pink 285, Lumogen F Orange 240 or Lumogen F Yellow 083, from BASF, Ludwigshafen, Germany. Further, it is also possible that the fluorescent substances are Phosphor S6, Uvitex OB/Tinopal OB, Uvitex FP, fluorescent orange, fluorescent yellow, fluorescent red, Lumilux red CD120, Lumilux yellow orange CD130, Lumilux Effect Sipi Yellow, Lumilux Green CD116 or FTX Series Laser Red Code FTX-3.

It is advantageous if the proportion of perylene dyes to binder is between 0.01% and 20%, preferably between 0.1% and 15%, further preferably between 0.2% and 10%, in particular wherein polyacrylates, polyurethanes, epoxides, polyesters, polyvinyl chlorides, rubber polymers, ethylene-acrylic acid copolymers, ethylene vinyl acetates, polyvinyl acetates, styrene block copolymers, phenol formaldehyde resin adhesives, melamines, alkenes, allyl ether, vinyl acetate, alkyl vinyl ether, conjugated dienes, styrene, acrylates and/or copolymer resins or mixtures thereof are used as binder.

Furthermore, individual raw materials which are excited in a specific wavelength range by means of UV radiation in the ranges 315 nm to 380 nm (UV-A) and/or 280 nm to 315 nm (UV-B) and/or 200 nm to 280 nm (UV-C) and/or 780 nm to 1400 nm (IR radiation) and emit in the wavelength range visible to the human eye (=VIS, approx. 400 nm to approx. 700 nm) can be used in the fluorescence varnish layer.

The following UV-excitable inorganic materials consisting of one or more foreign ions and a base lattice can be used as raw materials:

The following foreign ions or combinations can be used. Rare-earth ions and or ions of transition metals such as e.g.: Pr³⁺, Sm³⁺, Eu³⁺, Tb³⁺, Er³⁺, Dy³⁺, Tm³⁺, Cr³⁺, Mn⁴⁺, Mn²⁺, Cu⁺, Ag⁺, Sn²⁺, Sb³⁺, Pb²⁺, Bi³⁺, Ce³⁺ and Eu²⁺ contain.

Base lattice: borates (e.g. LaBO₃, SrB₆O₁₀, CaYO₄, SrB₄₀₇, YAl₃B₄O₁₂, SrB₈O₁₃, Ca₂B₅O₉Br), nitrides (e.g. CaAISiN₃, Sr₂Si₅N₈, MgSiN₂, GaN), oxynitrides (e.g. SrSi₂N₂O₂, α-SiAlON, β-SiAlON, oxides (e.g. Al₂O₃, CaO, Sc₂O₃, TiO₂, ZnO, Y₂O₃, ZrO₂, La₂O₃, Gd₂O₃, Lu₂O₃), halides and oxyhalides (e.g. CaF₂, CaCl₂, K₂SiF₆, LaOBr), aluminates (e.g. LiAlO₃, SrAl₂O₄, Y₃Al₅O₁₂, BaMgAl₁₁O₁₇, CaAl₂O₄, Sr₄Al₁₄O₂₅), silicates (e.g. Ba₂SiO₄, Sr₃SiO₅, Sr₃MgSi₂O₈, Sr₂MgSi₂O₇, CaSiO₃, Zn₂SiO₄, Ba₂SiO₄, Y₂SiO₅, CaMgSi₂₀₆, Ba₂Li₂Si₂O₇, LiCeBa₄Si₄O₁₄, Ca₃Al₂Si₃O₁₂), halosilicates (e.g. LaSiO₃Cl, Ba₅SiO₄Cl₆, Sr₅Si₄O₁₀Cl₆), phosphates (e.g. YPO₄, Ca₂P₂O₇, MgBaP₂O₇, Ca₃(PO₄)₂, MgBa₂(PO₄)₂), halophosphates (e.g. Ca₅(PO₄)₃Cl, Sr₅(PO₄)₃Cl), sulfides (e.g. ZnS, CaS, SrS, BaS, SrGa₂S₄, ZnGa₂S₄, ZnBa₂S₃), oxysulfides (e.g. Y₂O₂S, La₂O₂S, Gd₂O₂S, Lu₂O₂S), sulfates (e.g. Mg₂Ca(SO₄)₃), gallates (e.g. Y₃Ga₅O₁₂, CaGa₂O₄, Gd₃Ga₅O₁₂), vanadates (e.g. YVO₄), molybdates and tungstates (e.g. CaMoO₄, Sr₃WO₆, La₂W₃O₁₂, Tb₂Mo₃O₁₂, Li₃Ba₂La₃(MoO₄)₈), or inorganic substance classes such as borides, carbides, scandates, titanates, germanates and yttrates.

The conversion of infrared excitation radiation into visible light is called anti-Stokes luminescence or upconversion. The following materials can convert IR radiation into the visible spectral range through multi-step excitation processes:

Oxidic compounds such as e.g. Y₂O₃, ZrO₂, La₂MoO₆, LaNbO₄, LiYSiO₄), oxyhalides (e.g. YOCl, LaOCl, LaOBr, YOF, LaOF), oxysulfides (e.g. Y₂O₂S, La₂O₂S, Gd₂O₂S, Lu₂O₂S) and fluorides (e.g. YF₃, LaF₃, LiYF₄, NaYF₄, NaLaF₄, BaYF₅). To increase the quantum efficiency, the rare-earth combinations Yb³⁺—He³⁺, Yb³⁺—Tm³⁺ and Yb³⁺—Ho³⁺ are usually used as radiation centers in the anti-Stokes phosphors.

Furthermore, the following materials can be used as IR-VIS radiation converters (conversion from IR radiation into radiation visible to the human eye (VIS)): SrF₂: Er³⁺, YF₃: Yb³⁺, Tb³⁺ or CaF₂: Eu²⁺.

It is advantageous if the proportion of luminescent and infrared raw materials in relation to the binder is between 0.01% and 20%, preferably between 0.05% and 15%, further preferably between 0.1% and 10%, in particular wherein polyacrylates, polyurethanes, epoxides, polyesters, polyvinyl chlorides, rubber polymers, ethylene acrylic acid copolymers, ethylene vinyl acetates, polyvinyl acetates, styrene block copolymers, phenol formaldehyde resin adhesives, melamines, alkenes, allyl ether, vinyl acetate, alkyl vinyl ether, conjugated dienes, styrene, acrylates and/or copolymer resins or mixtures thereof are used as binder.

The embedding of security threads, in particular of the multilayer body, is effected e.g. on cylinder machines. In the course of the embedding the security thread or multilayer body coated on both sides with adhesive, in particular primers, is introduced into a paper pulp and led to a cylinder mold, where a fiber deposition has taken place but is not yet completed, so that the thread is then completely enclosed in the finished sheet. This incorporation method is generally known and described e.g. in DE 2408304 A1.

Furthermore, the described multilayer body, in particular security thread, can also be incorporated during the production of laminates. If for example two or more webs are laminated together, the multilayer body, in particular security thread, can be laminated onto one of the plies and then incorporated with it in the process actual laminating process. There is also the possibility that the multilayer body, in particular security thread, directly enters the laminating gap with it. In this case either one or more webs can be laminated together or else one or more webs can be processed with one or more glazes to form a laminate with the multilayer body, in particular security thread.

The primers or primer layers used for these embedding methods are selected from: single-layered adhesive, multilayered adhesive, aqueous-based adhesive, solvent-based adhesive, solvent-free adhesive, radiation-curing adhesive, thermally activatable adhesive, thermally curable adhesive or from combinations thereof.

It is provided in particular that at least one first primer layer is arranged on the underside of the at least one carrier layer and at least one second primer layer is arranged on the upper side of the at least one carrier layer, with the result that the at least one first and at least one second primer layers form the outer layers of the multilayer body. It is preferably also provided that in the case of structure a) after step vi) or in the case of structure b) after steps ii) and vi) the following step is further performed:
xv) applying at least one first primer layer to the underside of the carrier layer or the underside of the multilayer body and applying at least one second primer layer to the upper side of the carrier layer or the upper side of the multilayer body, with the result that the at least one first primer view and the at least one second primer layer form the outer layers of the multilayer body.

Further, it is possible that the at least one first and at least one second primer layers in each case have a layer thickness in the range of from 0.1 μm to 20 μm, in particular in the range of from 1 μm to 10 μm. The layer thickness of the individual adhesive layers within the primer layer lies in each case between 0.01 μm and 8 μm, preferably in each case between 0.05 μm and 5 μm.

It is provided in particular that the at least one primer layer is applied by means of a printing method and/or by means of pouring and/or by means of doctor blade. Further, it is advantageous if the at least one primer layer is applied at least partially, preferably over the whole surface.

In particular, it is provided that the at least one primer layer has at least one binder selected from: polyacrylates, polyurethanes, epoxides, polyesters, polyvinyl chlorides, rubber polymers, ethylene-acrylic acid copolymers, ethylene vinyl acetates, polyvinyl acetates, styrene block copolymers, phenol formaldehyde resin adhesives, melamines, alkenes, allyl ether, vinyl acetate, alkyl vinyl ether, conjugated dienes, styrene, acrylates and/or combinations thereof.

It is further preferably provided that the varnish from which the adhesive layer or the at least one primer layer is produced using an application method has at least one solvent selected from: water, aliphatic (benzine) hydrocarbons, cycloaliphatic hydrocarbons, terpene hydrocarbons, aromatic (benzene) hydrocarbons, chlorinated hydrocarbons, esters, ketones, alcohols, glycols, glycol ethers, glycol ether acetates and/or combinations thereof. This solvent or solvent mixture is removed again in large part in the application process.

It is further also possible that the at least one primer layer or the adhesive layer has at least one additive selected from: curing agents, crosslinkers, photoinitiators, fillers, stabilizers, inhibitors, corrosion inhibitors, additives such as e.g. flow additives, defoamers, deaerators, dispersing additives, wetting agents, lubricants, matting agents, rheology additives, pigments, corrosion-protection pigments, dyes, waxes and/or combinations thereof. Through a suitable choice of fillers or waxes, for example the tack of the primer layer at room temperature can be reduced.

In particular, a thermally activatable adhesive and/or an adhesive which has thermoplastic and/or UV-based raw materials has a solids content in the range of from 10% to 100%, preferably from 15% to 35%. The depositing using the varnishing machine can thereby be effected with good quality. It is preferably also provided that the adhesive has a non-tacky surface after the drying, in particular at room temperature. It is also advantageous if the choice of the raw materials of the adhesive is chosen in such a way that the processing temperature during the production of the multilayer body always lies above the glass transition temperature and below the melting point of the adhesive. During the embedding of the thread in the paper or polyamide the temperature lies in the range of from 10° C. to 220° C.

A primer layer comprising a multilayered adhesive layer provides the advantage in particular that an excellent adhesion can be achieved even between very challenging surfaces. Moreover, a multilayered structure makes primer layer systems possible with which plurality of chemical and physical resistances can be accomplished. Here the ability of the adhesive layer to resist the action of chemicals is called chemical resistance. The composition of the adhesive layers is preferably chosen such that they have a sufficient resistance to predefined chemicals. Further, it is advantageously provided that there is an intermediate adhesion of the individual layers to each other in the case of multilayered adhesives. This is effected through a suitable choice of the adhesive components.

In particular, it is proceed that the multilayer body is cut into threads after its production, preferably with a thread width in the range of from 1 mm to 10 mm, in particular in the range of from 2 mm to 6 mm.

The multilayer body, in particular security thread, is used in securities, banknotes, in particular bank bills, identification documents, or other security documents.

The multilayer body can be designed for example as a stamping film, laminating film, thread or also as a deep-drawing film.

In the following, the invention is explained by way of example with reference to several embodiment examples utilizing the attached drawings. The embodiment examples shown are therefore not to be understood as limitative.

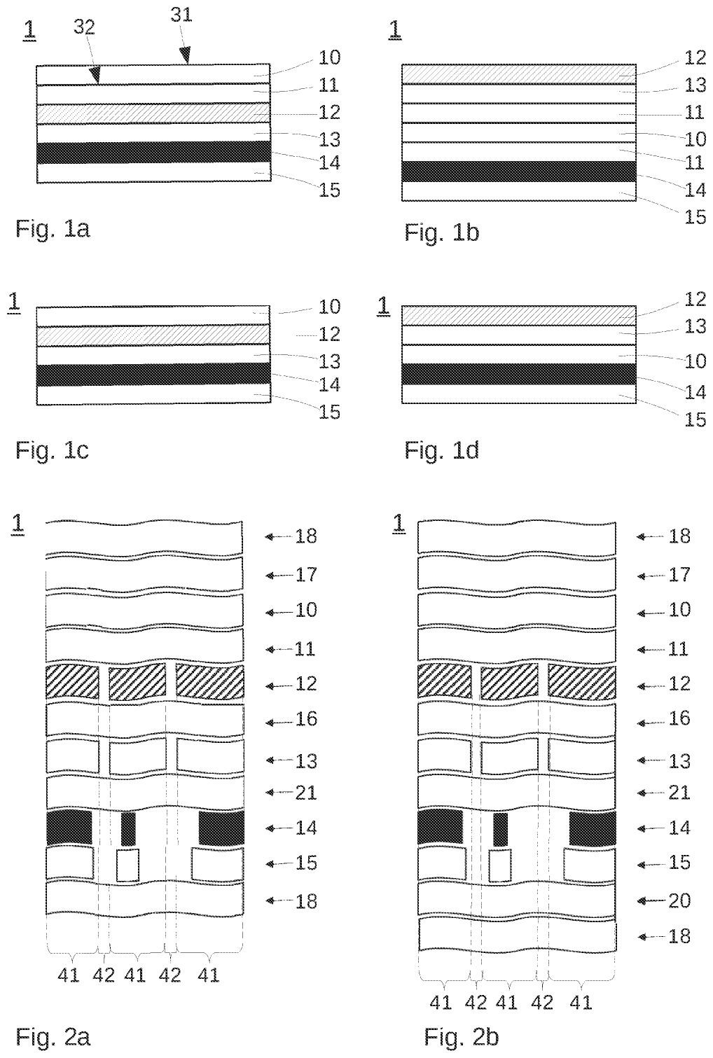

FIGS. 1a, b, c, d in each case show a schematic representation of a multilayer body

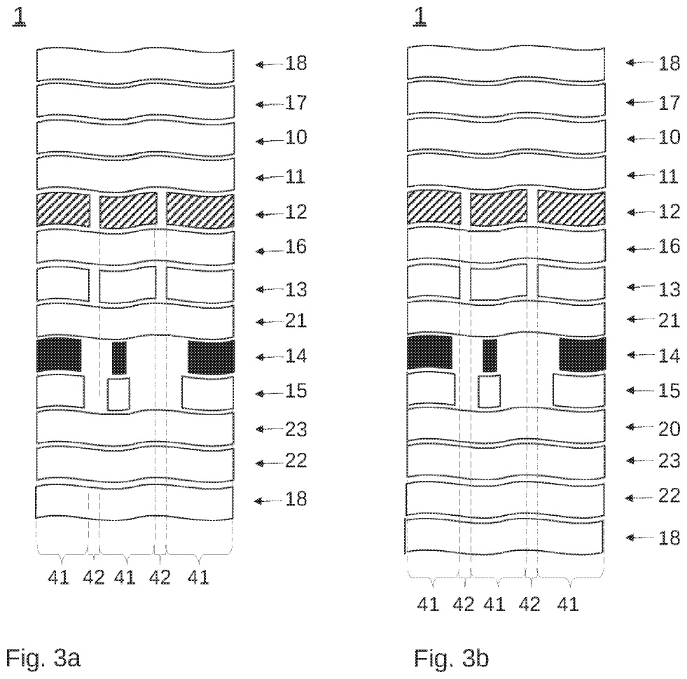

FIGS. 2a, 2b in each case show a schematic representation of an embodiment variant of a multilayer body

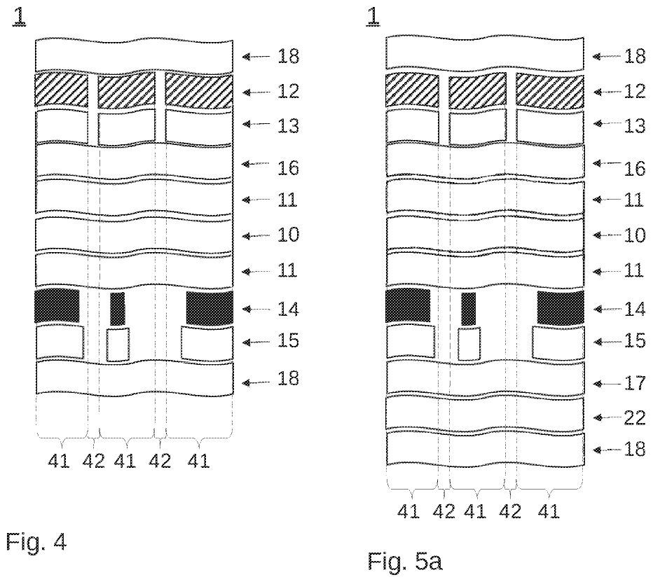

FIGS. 3a, 3b in each case show a schematic representation of an embodiment variant of a multilayer body

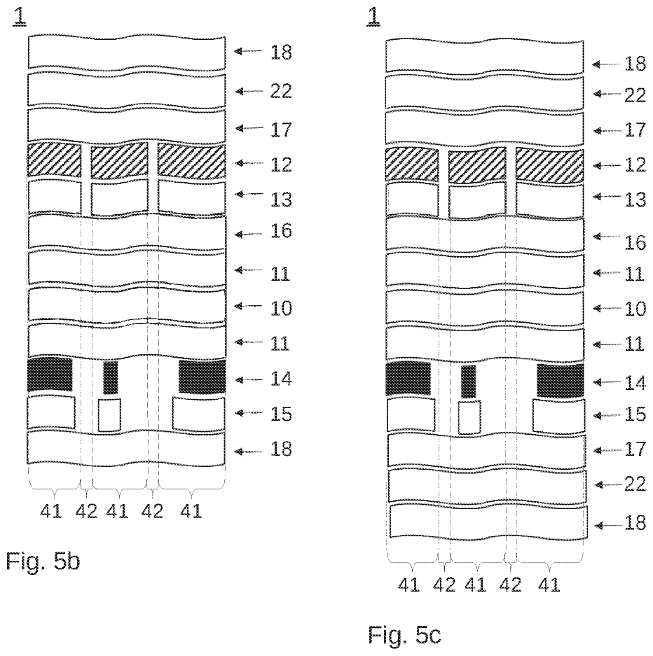

FIG. 4 shows a schematic representation of an embodiment variant of a multilayer body

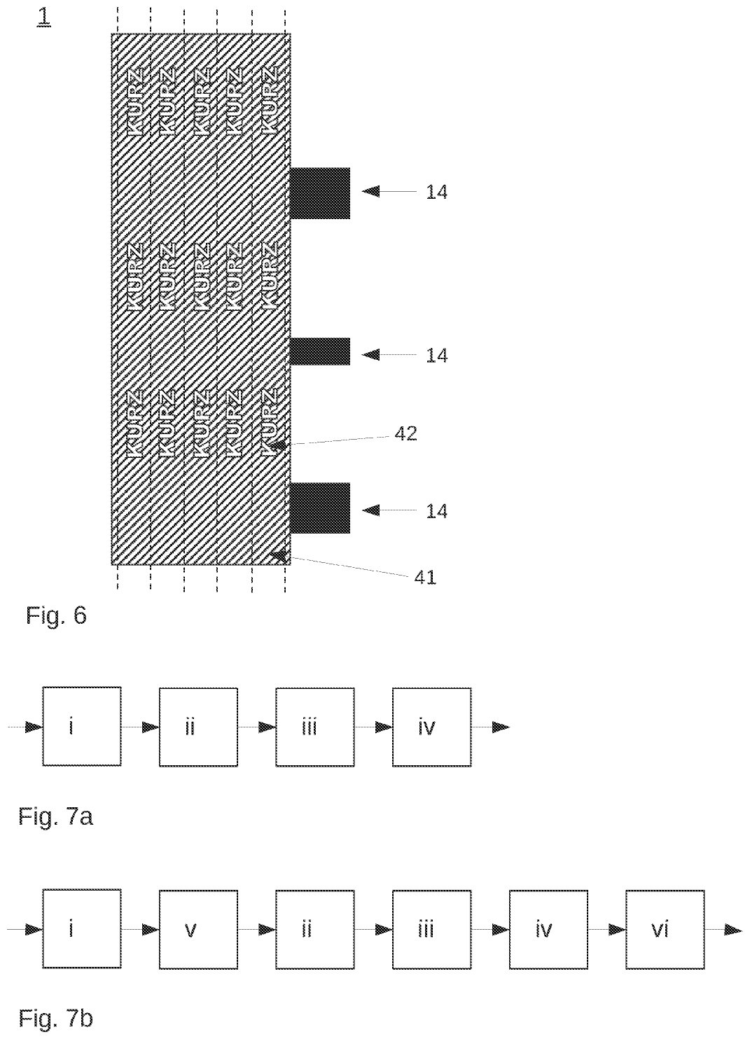

FIGS. 5a, b, c in each case show a schematic representation of an embodiment variant of a multilayer body

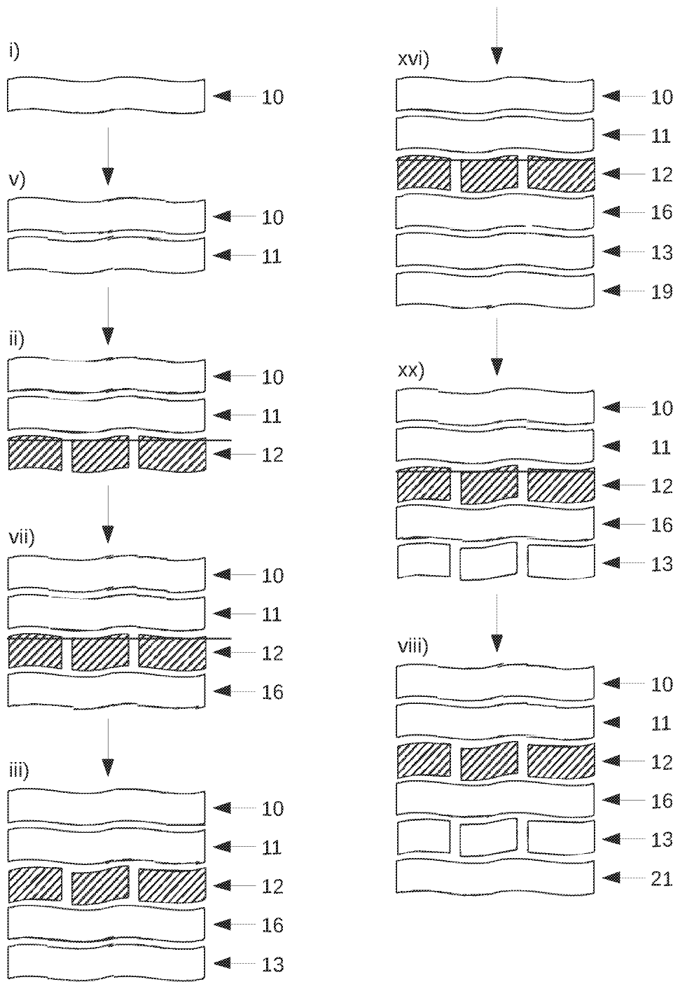

FIG. 6 shows a representation of a multilayer body in a perpendicular view onto the upper side of the multilayer body

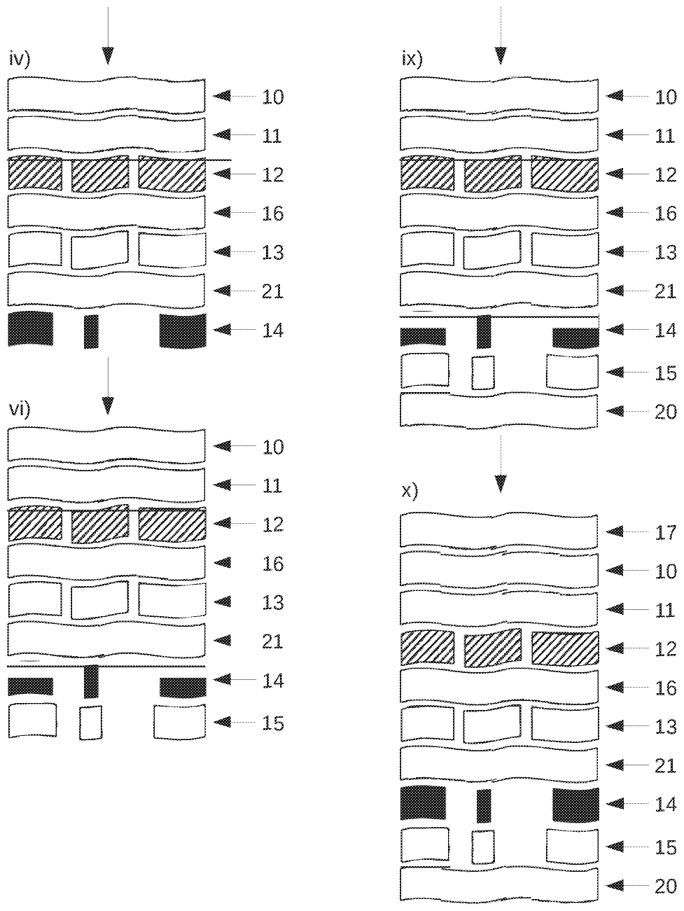

FIGS. 7a, b in each case show a schematic representation of a method for producing a multilayer body

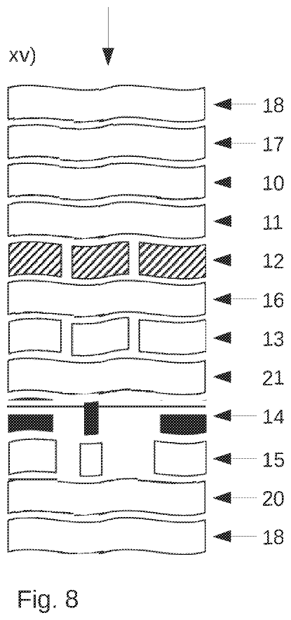

FIG. 8 shows an example method for producing a multilayer body

FIGS. 1c and 1d show an embodiment variant of a multilayer body 1, in particular a security thread for protecting security documents, wherein the multilayer body 1 has at least one carrier layer 10, at least one color layer 12, at least one metal layer 13 and at least one magnetic varnish layer 14, wherein the carrier layer 10, in particular the multilayer body 1, has an upper side 31 and an underside 32. The layers of the multilayer body 1 are arranged in such a way that in FIG. 1c the at least one color layer 12, the at least one metal layer 13, and the at least one magnetic varnish layer 14 are applied to the underside 32 of the carrier layer 10. FIG. 1c) thus shows an embodiment of the multilayer body according to structure a). In FIG. 1d the layers of the multilayer body 1 are arranged in such a way that the at least one metal layer 13 and the at least one color layer 12 are applied to the upper side 31 of the carrier layer 10 and the at least one magnetic varnish layer 14 are applied to the underside 32 of the carrier layer 10. FIG. 1d thus shows an embodiment of the multilayer body 1 according to structure b).

FIGS. 1a and 1b show an embodiment variant of a multilayer body 1, wherein the structure is identical to that from FIGS. 1c and 1d, except that the multilayer body has at least one first adhesion-promoter layer 11 and at least one masking varnish layer 15. The layers of the multilayer body 1 are arranged in such a way that in FIG. 1a the at least one first adhesion-promoter layer 11, the at least one color layer 12, the at least one metal layer 13, the at least one magnetic varnish layer 14 and the at least one masking varnish layer 15 are applied to the underside 32 of the carrier layer 10. FIG. 1a thus shows an embodiment of the multilayer body 1 according to structure a). In FIG. 1b the layers of the multilayer body 1 are arranged in such a way that the at least one first adhesion-promoter layer 11, the at least one metal layer 13 and the at least one color layer 12 are applied to the upper side 31 of the carrier layer 10 and the at least one first adhesion-promoter layer 11, the at least one magnetic varnish layer 14 and the at least one masking varnish layer 15 are applied to the underside 32 of the carrier layer 10. FIG. 1b thus shows an embodiment of the multilayer body 1 according to structure b). It may be mentioned here that the layers are applied in the above-named order, i.e. the first-named layer is in each case the layer which is in direct contact with the carrier layer 10.

It is advantageously provided that the at least one carrier layer 10 has a layer thickness in the range of from 1 μm to 500 μm, preferably in the range of from 6 μm to 23 μm, further preferably in the range of from 6 μm to 16 μm.

It is also possible that the at least one first adhesion-promoter layer 11 has a layer thickness in the range of from 0.01 μm to 30 μm, preferably in the range of from 0.1 μm to 5 μm.

It is advantageously provided that the at least one color layer 12 has a layer thickness in the range of from 0.1 μm to 30 μm, preferably in the range of from 0.1 μm to 5 μm.

Further, it is preferably possible that the at least one color layer 12 comprises one or more color layers and/or a thin-film layer system and/or effect pigments and/or an optically variable element for dyeing the metal layer 13.

It is also possible that the at least one metal layer 13 comprises a material or a combination of materials selected from: aluminum, silver, chromium, copper, tin, gold, zinc or an alloy of the above-named metals.

It is preferably also provided that the at least one metal layer 13 comprises a material selected from: blackened aluminum, in particular substoichiometric AlxOy, or oxidized silver.

It is advantageously provided that the at least one magnetic varnish layer 14 has a layer thickness in the range of from 0.1 μm to 25 μm, preferably in the range of from 0.5 μm to 17 μm.

It is preferably possible that the at least one magnetic varnish layer 14 is applied in the decoration or over the whole surface.

It is further also possible that the at least one magnetic varnish layer 14 is arranged register-accurately or registration-accurately relative to the at least one color layer 12 and/or the at least one metal layer 13.

It is advantageously provided that the at least one masking varnish layer 15 has a layer thickness in the range of from 0.1 μm to 50 μm, preferably in the range of from 0.5 μm to 25 μm, further preferably in the range of from 0.1 μm to 5 μm.

It is also provided that the at least one masking varnish layer 15 is arranged registration-accurately or register-accurately relative to the at least one magnetic varnish layer 14, with the result that the at least one masking varnish layer 15 covers the at least one magnetic varnish layer 14.

Further, it is preferably possible that the at least one masking varnish layer 15 is provided in a first area 41 and is not provided in a second area 42.

FIG. 2a shows a further embodiment variant of a multilayer body 1, in particular according to structure a), wherein a first primer layer 18 is further arranged on the underside 32 of the carrier layer 10.

Further, in this embodiment, in particular in structure a), a replication layer 16 is arranged on the underside 32 of the carrier layer 10 between the color layer 12 and the metal layer 13.

It is preferably provided that the at least one replication layer 16, in particular in structure a), has a layer thickness in the range of from 0.1 μm to 30 μm, in particular in the range of from 0.5 μm to 10 μm.

Further, it is possible that the at least one replication layer 16, in particular in structure a), has optically variable structures, in particular diffractive structures and/or refractive structures and/or isotropic matte structures and/or anisotropic matte structures, which are preferably introduced by means of thermal replication and/or UV replication.

The color layer 12 is arranged in the decoration in FIG. 2a. It is preferably also possible that the color layer 12 is arranged registration-accurately or register-accurately relative to the at least one replication layer 16. Further, in this embodiment the at least one color layer 12 is provided in a first area 41 and is not provided in a second area 42.

It has proved to be advantageous if the at least one color layer 12 is designed as an etch resist for structuring the at least one metal layer 13 and/or as an exposure mask for structuring an etch resist.

It is expediently provided that the at least one metal layer 13 is arranged register-accurately or registration-accurately, in particular in exact register, relative to the at least one color layer 12. In particular due to the structuring by means of etching, the metal layer 13 can be arranged in exact register with the color layer 12. The color layer 12 which is applied in the decoration then serves as an exposure mask for a photosensitive layer 19 which is applied underneath the metal layer 13. The upper side 31 is then exposed to light perpendicularly, with the result that the photosensitive layer 19 reduces its resistance to solvents or its solubility with respect to solvents in the exposed areas, preferably in the second areas 42. The photosensitive layer 19 is then removed with a solvent in the second areas 42. The resulting structured photosensitive layer then serves as an etch resist, with the result that the metal layer 13 is preserved in the areas covered by the color layer 12, in particular the first area 41, and is removed by the etching in the second areas 42. The photosensitive layer 19 is removed again after the etching or the structuring of the metal layer 13. By exact register is meant here that there is no deviation between the color layer 12 and the metal layer 13. In addition, this procedure makes it possible to dispense with a sensory monitoring for maintaining the register or registration accuracy. The at least one metal layer 13 is advantageously provided in a first area 41 and is not provided in a second area 42.

It is advantageously possible that the at least one magnetic varnish layer 14 is provided in a partial area of the first area 41 and is not provided in a second area 42, with the result that for an observer viewing the upper side 31 of the multilayer body 1 the at least one magnetic varnish layer 14 is covered by the at least one color layer 12 and/or the at least one metal layer 13. In particular, the partial area is spaced apart from the boundaries of the first area 41, with the result that it is ensured that the at least one magnetic varnish layer 14 is always concealed by the at least one color layer 12 or the at least one metal layer 13 when the upper side 31 of the multilayer body 1 or the carrier layer 10 is viewed perpendicularly.

Furthermore, in the embodiment according to FIG. 2a a corrosion-protection varnish layer 21 is arranged between the metal layer 13 and the magnetic varnish layer 14. This corrosion-protection varnish layer 21 is provided in particular if e.g. aluminum is used as metal layer 13. The corrosion-protection varnish layer 21 in this case prevents direct contact of the metal layer 13 with the magnetic varnish layer 14, with the result that corrosion of one of the two layers is prevented.

It is preferably also possible that in structure a) at least one corrosion-protection varnish layer 21 is arranged, in particular over the whole surface or at least in areas, between the at least one metal layer 13 and the at least one magnetic varnish layer 14.

It is further possible that in structure a) the corrosion-protection varnish layer 21 has a layer thickness in the range of from 0.1 μm to 30 μm, preferably in the range of from 0.1 μm to 5 μm.

Further, in the embodiment according to FIG. 2a a second adhesion-promoter layer 17 and a second primer layer 18 are arranged on the upper side 31 of the carrier layer 10.

It is advantageously provided that in structure a) at least one second adhesion-promoter layer 17 is arranged, in particular over the whole surface or at least in areas, on the upper side 31 of the at least one carrier layer 10.

It is further provided that in structure a) the at least one second adhesion-promoter layer 17 has a layer thickness in the range of from 0.1 μm to 30 μm, preferably in the range of from 0.1 μm to 5 μm.

In particular, it is provided that at least one first primer layer 18 is arranged on the underside 32 of the at least one carrier layer 10 and at least one second primer layer 18 is arranged on the upper side 31 of the at least one carrier layer 10, with the result that the at least one first and at least one second primer layers 18 form the outer layers of the multilayer body 1.

Further, it is provided that the at least one first and at least one second primer layers 18 in each case have a layer thickness in the range of from 0.1 μm to 20 μm, in particular in the range of from 1 μm to 10 μm.

FIG. 2b shows a further embodiment of a multilayer body 1, in particular according to structure a), wherein the structure of the multilayer body 1 is identical to the structure from FIG. 2a, except that a fluorescence varnish layer 20 is arranged between masking varnish layer 15 and the primer layer 18.

It is preferably provided that in structure a) at least one fluorescence varnish layer 20 is arranged, in particular over the whole surface or at least in areas, on the underside 32 of the carrier layer 10, in particular underneath the at least one masking varnish layer 15.

In particular, in structure a) the fluorescence varnish layer 20 has a layer thickness in the range of from 0.1 μm to 10 μm, preferably in the range of from 0.1 μm to 2 μm.

FIG. 3a shows an embodiment variant of a multilayer body 1, wherein it has the same structure as the multilayer body 1 in FIG. 2a, except that the multilayer body 1 now have a third adhesion-promoter layer 23 and a further carrier layer 22, which are arranged underneath the masking varnish layer 15. In this embodiment the first primer layer 18 is arranged underneath the one further carrier layer 22. It can also be possible that a second adhesion-promoter layer 17 is arranged between the one further carrier layer 22 and the first primer layer 18.

It is advantageously provided that in structure a) at least one third adhesion-promoter layer 23 is arranged on the underside 32 of the at least one carrier layer 10, in particular underneath the at least one masking varnish layer 15.

It is preferably also possible that in structure a) the at least one third adhesion-promoter layer 23 has a layer thickness in the range of from 0.1 μm to 30 μm, preferably in the range of from 0.1 μm to 10 μm.

It is advantageously possible that in structure a) at least one further carrier layer 22 is arranged on the underside 32 of the at least one carrier layer 10, in particular underneath the at least one third adhesion-promoter layer 23.

It is also provided that in structure a) the at least one further carrier layer 22 has a layer thickness in the range of from 1 μm to 20 μm, in particular in the range of from 5 μm to 12 μm.

FIG. 3b shows a further embodiment of a multilayer body 1, in particular according to structure a), wherein the structure of the multilayer body 1 is identical to the structure from FIG. 3a, except that a fluorescence varnish layer 20 is arranged between masking varnish layer 15 and the third adhesion-promoter layer 23.

FIG. 4 shows a further embodiment variant of a multilayer body 1, in particular according to structure b), wherein a replication layer 16 is arranged on the upper side 31 of the carrier layer 10 between the first adhesion-promoter layer 11 and the metal layer 13. Further, in this embodiment a first primer layer 18 is arranged on the underside 32 of the carrier layer 10 or the multilayer body 1 and a second primer layer 18 is arranged on the upper side 31, with the result that these primer layers form the outer layers of the multilayer body 1.

It is preferably provided that in structure b) the at least one replication layer 16 has a layer thickness in the range of from 0.1 μm to 30 μm, in particular in the range of from 0.5 μm to 10 μm.

Further, it is preferably possible that in structure b) the at least one replication layer 16 has optically variable structures, in particular diffractive structures and/or refractive structures and/or isotropic matte structures and/or anisotropic matte structures, which are preferably introduced by means of thermal replication and/or UV replication.

FIG. 5a shows a further embodiment variant of a multilayer body 1, in particular according to structure b), wherein the structure of the multilayer body 1 is substantially identical to that from FIG. 4, with the difference that a second adhesion-promoter layer 17 and a further carrier layer 22 are arranged underneath the masking varnish layer 15.

In particular, it is provided that in structure b) at least one second adhesion-promoter layer 17 is arranged on the upper side 31 of the carrier layer 10, in particular on top of the at least one color layer 12 and/or at least one second adhesion-promoter layer 17 is arranged on the underside 32 of the carrier layer 10, in particular underneath the at least one masking varnish layer 15.

It is also possible that in structure b) the at least one second adhesion-promoter layer 17 has a layer thickness in the range of from 0.1 μm to 30 μm, preferably in the range of from 0.1 μm to 10 μm.

FIG. 5b shows a further embodiment variant of a multilayer body 1, in particular according to structure b), wherein the structure of the multilayer body 1 is substantially identical to that from FIG. 4, except that in this variant a second adhesion-promoter layer 17 and a further carrier layer 22 are arranged on top of the color layer 12.

FIG. 5c shows a further embodiment variant of a multilayer body 1, in particular according to structure b), in which in each case a further carrier layer 22 is arranged both on the underside 32 and on the upper side 31 by means of a second adhesion promoter. This structure is characterized by a particular stability and further makes the multilayer body 1 more protected against forgery.

FIG. 6 shows a representation of a multilayer body 1 in a perpendicular view onto the upper side 31 of the multilayer body 1, wherein the magnetic varnish layer 14 is uncovered on the right-hand side for better illustration. It is hereby clear that the magnetic varnish layer 14 extends over the entire width of the multilayer body 1, but in the left-hand image area is covered by the at least one color layer 12 and the at least one metal layer 13. The magnetic varnish layer 14 is here provided only in the second areas 42. In the second areas 42 the color layer 12 and the metal layer 13 are deposited over the whole surface. Whereas the color layer 12 and the metal layer 13 are not deposited in the first areas 41, represented here by the lettering “Kurz”. It is then possible that the replication layer 16 is visible in the first area 41 and thus generates an item of optically variable information which is visible to the observer.

FIG. 7a shows a schematic representation of a method for producing a multilayer body, wherein the following steps are carried out
i) providing at least one carrier layer 10, having an upper side 31 and an underside 32,
ii) applying at least one color layer 12,
iii) applying at least one metal layer 13,
iv) applying at least one magnetic varnish layer 14,
wherein the steps are carried out in such a way that the multilayer body (1) has the following structure, in particular in the specified order:
a) the at least one color layer 12, the at least one metal layer 13 and the at least one magnetic varnish layer 14 are applied to the underside 32 of the carrier layer 10; or
b) the at least one metal layer 13 and the at least one color layer 12 are applied to the upper side 31 of the carrier layer 10 and the at least one magnetic varnish layer 14 are applied to the underside 32 of the carrier layer 10.

In particular, it is provided that in the case of structure a) after step i) the steps are carried out in the order ii), iii), iv) on the underside 32 of the carrier layer 10 provided in step i), or in the case of structure b) after step i) the steps are carried out in the order iii), ii) on the upper side 31 of the carrier layer 10 provided in step i) and step iv) is carried out on the underside 32 of the carrier layer 10 provided in step i).

FIG. 7b shows a schematic representation of a method for producing a multilayer body 1, wherein the following steps are carried out
i) providing at least one carrier layer 10, having an upper side 31 and an underside 32,
v) applying at least one first adhesion-promoter layer 11,
ii) applying at least one color layer 12,
iii) applying at least one metal layer 13,
iv) applying at least one magnetic varnish layer 14,
vi) applying at least one masking varnish layer 15,
wherein the steps are carried out in such a way that the multilayer body 1 has the following structure, in particular in the specified order:
   a) the at least one first adhesion-promoter layer 11, the at least one color layer 12, the at least one metal layer 13, the at least one magnetic varnish layer 14 and the at least one masking varnish layer 15 are applied to the underside 32 of the carrier layer 10;
      or
   b) the at least one first adhesion-promoter layer 11, the at least one metal layer 13 and the at least one color layer 12 are applied to the upper side 31 of the carrier layer 10 and the at least one first adhesion-promoter layer 11, the at least one magnetic varnish layer 14 and the at least one masking varnish layer 15 are applied to the underside 32 of the carrier layer 10.

In particular, it is provided that in the case of structure a) after step i) the steps are carried out in the order v), ii), iii), iv), vi) on the underside 32 of the carrier layer 10 provided in step i), or in the case of structure b) after step i) the steps are carried out in the order v), iii), ii) on the upper side 31 of the carrier layer 10 provided in step i) and the steps are carried out in the order v), iv), vi) on the underside 32 of the carrier layer 10 provided in step i).

FIG. 8 shows an example method for producing a multilayer body 1, in particular according to structure a). First, a carrier layer 10 is provided in step i). Then, a first adhesion-promoter layer 11 is applied in step v). In particular, it is provided that in step v) the at least one first adhesion-promoter layer 11 is applied with a layer thickness in the range of from 0.1 μm to 30 μm, preferably in the range of from 0.1 μm to 5 μm.

Subsequently, the at least one color layer 12 is applied in the decoration in step ii). It is advantageously provided that in step ii) the at least one color layer 12 is applied in a first area 41 and is not applied in a second area 42.

Further, it is possible that in step ii) the at least one color layer 12 is designed as an etch resist for structuring the at least one metal layer 13 and/or as an exposure mask for structuring an etch resist. In the embodiment shown in FIG. 8 the color layer 12 serves as an exposure mask for a photosensitive layer 19.

It is preferably possible that in step ii) the at least one color layer 12 is formed of one or more color layers and/or a thin-film layer system and/or effect pigments and/or an optically variable element for dyeing the metal layer 13.

After the application of the color layer 12, the application of a replication layer 16 is effected in step vii), in particular by means of gravure printing. In particular, it is provided that in step vii) optically variable structures, in particular diffractive structures and/or refractive structures and/or isotropic matte structures and/or anisotropic matte structures, are introduced into the at least one replication layer 16 by means of thermal replication and/or UV replication.

Then, a metal layer 13 is applied in step iii). In the embodiment variant shown in FIG. 8 the at least one metal layer 13 is applied over the whole surface in step iii). However, it is also possible that in step iii) the at least one metal layer 13 is applied in a first area 41 and is not applied in a second area 42. Further, it is also possible that the application of the at least one metal layer 13 in step iii) is effected register-accurately or registration-accurately, in particular in exact register, relative to the at least one color layer 12. It is preferably provided that in step iii) the at least one metal layer 13 is applied by means of vapor deposition and/or sputtering.

After the application of the metal layer 13 in step iii) a photosensitive layer 19 is applied, in particular in structure a) and in step xvi), over the whole surface, in particular with the result that the photosensitive layer 19 is applied underneath the metal layer 13. This is followed by further steps, which are not represented in FIG. 8. In particular, it is provided that in structure a) after step xvi) the following step is further performed:
xvii) exposing the at least one photosensitive layer to light from the upper side 31 of the multilayer body 1, with the result that the at least one colored varnish layer serves as an exposure mask for the at least one photosensitive layer 19 and the at least one photosensitive layer 19 is activated by radiation, in particular UV radiation, with the result that the at least one photosensitive layer 19 becomes soluble in a particular solvent, in particular acidic or basic solutions, in the second areas 42.

Further, it is preferably provided that in structure a) after step xvii) the following step is further performed:
xviii) structuring the at least one photosensitive layer 19 by means of a solvent, in particular an acidic or basic solution, with the result that the at least one photosensitive layer 19 is removed in the second areas 42 and is preserved in the first areas 41.

It is also possible in particular that in structure a) after step xviii) the following step is further performed:
xix) demetallizing the at least one metal layer 13 by means of etching, wherein the at least one photosensitive layer 19 serves as an etch resist and the at least one metal layer 13 is removed in the second areas 42 and is preserved in the first areas 41, in particular with the result that the metal layer 13 is demetallized in exact register with the at least one color layer 12.

After step xix) the photosensitive layer 19 is subsequently removed in step xx), as also shown in FIG. 8. Due to the demetallization of the metal layer 13, the metal layer 13 is now arranged in exact register with the color layer 12.

After the removal of the photosensitive layer 19 in step xx), the application of at least one corrosion-protection varnish layer 21, in particular over the whole surface or at least in areas, is now effected in step viii), in order to prevent a direct contact of the at least magnetic varnish layer 14 with the at least one metal layer 13.

Then, a magnetic varnish layer 14 is applied in step iv). Here, it is provided in particular that the at least one magnetic varnish layer 14 is applied in the decoration or over the whole surface. However, it is also possible that in step iv) the at least one magnetic varnish layer 14 is applied register-accurately or registration-accurately relative to the at least one color layer 12 and/or the at least one metal layer 13. However, it is also possible that in step iv) the at least one magnetic varnish layer 14 is applied in a partial area of the first area 41 and is not applied in a second area 42, with the result that for an observer viewing the upper side 31 of the multilayer body 1 the at least one magnetic varnish layer 14 is covered by the at least one color layer 12 and/or the at least one metal layer 13. Furthermore, it is preferably provided that in step iv) the at least one magnetic varnish layer 14 is applied by means of pad printing and/or offset printing and/or digital printing and/or inkjet printing and/or xerographic printing and/or flexographic printing and/or dye-sublimation printing and/or thermal-transfer printing and/or gravure printing and/or slot die and/or screen printing.

After the application of the magnetic varnish layer 14 in step iv) a masking varnish layer 15 is applied in step vi). This is to conceal the magnetic varnish layer 14 when the underside 32 of the multilayer body 1 is viewed, with the result that the magnetic varnish layer 14 is not visible to the observer. It is advantageously possible that in step vi) the at least one masking varnish layer 15 is applied registration-accurately or register-accurately relative to the at least one magnetic varnish layer 14, with the result that the at least one masking varnish layer 15 covers the at least one magnetic varnish layer 14. However, it is also preferably provided that in step vi) the at least one masking varnish layer 15 is applied by means of pad printing and/or offset printing and/or digital printing and/or inkjet printing and/or xerographic printing and/or flexographic printing and/or dye-sublimation printing and/or thermal-transfer printing and/or gravure printing and/or slot die and/or screen printing.

In the example method shown in FIG. 8, after the application of the masking varnish layer 15 in step vi), step ix) for applying a fluorescence varnish layer 20 is carried out, wherein the at least one fluorescence varnish layer 20 is applied to the underside 32 of the at least one masking varnish layer 15.

Then, or in particular after step vi), in step x) the application of a second adhesion-promoter layer 17, in particular over the whole surface or at least in areas, to the upper side 31 of the carrier layer 10 is effected.

Further, it is also possible, after step vi), in step xi) to apply a third adhesion-promoter layer 23, in particular over the whole surface or at least in areas, to the underside 32 of the at least one carrier layer 10, in particular underneath the at least one masking varnish layer 15. This step is not represented in FIG. 8 and represents a further option. It is then provided in particular further to carry out the following step: xii) applying at least one further carrier layer 22 to the underside 32 of the at least one carrier layer 10, in particular underneath the at least one third adhesion-promoter layer 23.

In FIG. 8, finally, in step xv) at least one first primer layer 18 is applied to the underside 32 of the carrier layer 10 or the underside 32 of the multilayer body 1 and at least one second primer layer 18 is applied to the upper side 31 of the carrier layer or the upper side 31 of the multilayer body 1, with the result that the at least one first primer view and the at least one second primer layer 18 form the outer layers of the multilayer body 1.

The method shown in FIG. 8 is only by way of example. It is understood that it is also possible to carry out still further steps or to carry out the steps in a different order. It is thus possible in particular that in the case of structure b) between steps v) and iv), in particular ii) and iii), the following step is further carried out: xiii) applying at least one replication layer 16, in particular by means of gravure printing, with the result that the at least one replication layer 16 is applied to the upper side 31 of the at least one carrier layer 10 between the at least one first adhesion-promoter layer 11 and/or the at least one carrier layer 10 and the at least one metal layer 13.

For example, it is also provided that in the case of structure b) and in step xiii) optically variable structures, in particular diffractive structures and/or refractive structures and/or isotropic matte structures and/or anisotropic matte structures, are introduced into the at least one replication layer 16 by means of thermal replication and/or UV replication.

Furthermore, it is possible that in the case of structure b) after step ii) and/or after step vi) the following step is further performed:
xiv) applying at least one second adhesion-promoter layer 17, in particular such that the at least one second adhesion-promoter layer 17 is arranged on top of the at least one color layer 12 and/or underneath the at least one masking varnish layer 15.

Further, it is also possible that in structure b) after step ii) the following step is further performed:
xxi) demetallizing the at least one metal layer 13 by means of etching, wherein the at least one color layer 12 serves as an etch resist and the at least one metal layer 13 is removed in the second areas 42 and is preserved in the first areas 41, in particular with the result that the metal layer 13 is demetallized in exact register with the at least one color layer 12.

### LIST OF REFERENCE NUMBERS

1 multilayer body
10 carrier layer
11 first adhesion-promoter layer
12 color layer
13 metal layer
14 magnetic varnish layer
masking varnish layer
16 replication layer
17 second adhesion-promoter layer
18 primer layer
19 photosensitive layer
20 fluorescence varnish layer
21 corrosion-protection varnish layer
22 further carrier layer
23 third adhesion-promoter layer
31 upper side
32 underside
41 first area
42 second area

1. A multilayer body,
wherein the multilayer body has at least one carrier layer, at least one color layer, at least one metal layer and at least one magnetic varnish layer, wherein the carrier layer has an upper side and an underside, and wherein the layers of the multilayer body are arranged in such a way that
a) the at least one color layer, the at least one metal layer, and the at least one magnetic varnish layer are applied to the underside of the carrier layer; or
b) the at least one metal layer and the at least one color layer are applied to the upper side of the carrier layer and the at least one magnetic varnish layer are applied to the underside of the carrier layer.

2. The multilayer body according to claim 1, wherein the multilayer body has at least one first adhesion-promoter layer and/or at least one masking varnish layer.

3. The multilayer body according to claim 2, wherein, in structure a) at least one replication layer is arranged between the at least one color layer and the at least one metal layer.

4. The multilayer body according to claim 3, wherein, in structure a) the at least one replication layer has a layer thickness in the range of from 0.1 μm to 30 μm.

5. The multilayer body according to claim 3, wherein, in structure a) the at least one replication layer has optically variable structures, and/or refractive structures and/or isotropic matte structures and/or anisotropic matte structures.

6. The multilayer body according to claim 1, wherein, in structure a) at least one corrosion varnish layer is arranged, between the at least one metal layer and the at least one magnetic varnish layer.

7. The multilayer body according to claim 6, wherein, in structure a) the corrosion varnish layer has a layer thickness in the range of from 0.1 μm to 30 μm.

8-9. (canceled)

10. The multilayer body according to claim 1, wherein, in structure a) at least one second adhesion-promoter layer is arranged, on the upper side of the at least one carrier layer.

11. The multilayer body according to claim 10, wherein, in structure a) the at least one second adhesion-promoter layer has a layer thickness in the range of from 0.01 μm to 30 μm.

12. The multilayer body according to claim 1, wherein, in structure a) at least one third adhesion-promoter layer is arranged on the underside of the at least one carrier layer.

13. The multilayer body according to claim 12, wherein, in structure a) the at least one third adhesion-promoter layer has a layer thickness in the range of from 0.01 μm to 30 μm.

14. The multilayer body according to claim 12, wherein, in structure a) at least one further carrier layer is arranged on the underside of the at least one carrier layer.

15. (canceled)

16. The multilayer body according to claim 1, wherein, in structure b) at least one replication layer is arranged between the first adhesion-promoter layer and/or the carrier layer on the upper side of the carrier layer and the metal layer.

17. The multilayer body according to claim 16, wherein, in structure b) the at least one replication layer has a layer thickness in the range of from 0.1 μm to 30 μm.

18. The multilayer body according to claim 16, wherein, in structure b) the at least one replication layer has optically variable structures, and/or refractive structures and/or isotropic matte structures and/or anisotropic matte structures.

19. The multilayer body according to claim 1, wherein, in structure b) at least one second adhesion-promoter layer is arranged on the upper side of the carrier layer and/or at least one second adhesion-promoter layer is arranged on the underside of the carrier layer.

20. The multilayer body according to claim 19, wherein, in structure b) the at least one second adhesion-promoter layer has a layer thickness in the range of from 0.01 μm to 30 μm.

21. The multilayer body according to claim 1, wherein at least one first primer layer is arranged on the underside of the at least one carrier layer and at least one second primer layer is arranged on the upper side of the at least one carrier layer, with the result that the at least one first and at least one second primer layers form the outer layers of the multilayer body.

22. The multilayer body according to claim 21, wherein the at least one first and at least one second primer layers in each case have a layer thickness in the range of from 0.1 μm to 20 μm.

23-25. (canceled)

26. The multilayer body according to claim 1, wherein the at least one color layer is arranged in the decoration.

27. The multilayer body according to claim 1, wherein the at least one color layer is provided in a first area and is not provided in a second area.

28. The multilayer body according to claim 1, wherein the at least one color layer is designed as an etch resist for structuring the at least one metal layer and/or as an exposure mask for structuring an etch resist.

29-31. (canceled)

32. The multilayer body according to claim 1, wherein the at least one metal layer is arranged register-accurately or registration-accurately.

33. The multilayer body according to claim 1, wherein the at least one metal layer is provided in a first area and is not provided in a second area.

34. The multilayer body according to claim 1, wherein the at least one magnetic varnish layer has a layer thickness in the range of from 0.1 μm to 25 μm.

35. The multilayer body according to claim 1, wherein the at least one magnetic varnish layer is applied in the decoration or over the whole surface.

36. The multilayer body according to claim 1, wherein the at least one magnetic varnish layer is arranged register-accurately or registration-accurately relative to the at least one color layer and/or the at least one metal layer.

37. The multilayer body according to claim 27, wherein the at least one magnetic varnish layer is provided in a partial area of the first area and is not provided in a second area, with the result that for an observer viewing the upper side of the multilayer body the at least one magnetic varnish layer is covered by the at least one color layer and/or the at least one metal layer.

38. The multilayer body according to claim 2, wherein the at least one masking varnish layer has a layer thickness in the range of from 0.1 μm to 50 μm.

39. The multilayer body according to claim 2, wherein the at least one masking varnish layer is arranged registration-accurately or register-accurately relative to the at least one magnetic varnish layer with the result that the at least one masking varnish layer covers the at least one magnetic varnish layer.

40. The multilayer body according to claim 2, wherein the at least one masking varnish layer is provided in a first area and is not provided in a second area.

41. A method for producing a multilayer body, wherein the following steps are carried out
i) providing at least one carrier layer, having an upper side and an underside,
ii) applying at least one color layer,
iii) applying at least one metal layer,
iv) applying at least one magnetic varnish layer,
wherein the steps are carried out in such a way that the multilayer body has the following structure:
a) the at least one color layer, the at least one metal layer and the at least one magnetic varnish layer are applied to the underside of the carrier layer; or
b) the at least one metal layer and the at least one color layer are applied to the upper side of the carrier layer and the at least one magnetic varnish layer are applied to the underside of the carrier layer.

42. The method according to claim 41, wherein in the case of structure a) after step i) the steps are carried out in the order ii), iii), iv) on the underside of the carrier layer provided in step i), or in the case of structure b) after step i) the steps are carried out in the order iii), ii) on the upper side of the carrier layer provided in step i) and step iv) is carried out on the underside of the carrier layer provided in step i).

43. The method according to claim 41, wherein the following steps are further carried out
v) applying at least one first adhesion-promoter layer, and/or
vi) applying at least one masking varnish layer,
wherein the steps are carried out in such a way that the multilayer body has the following structure:
a) the at least one adhesion-promoter layer, the at least one color layer, the at least one metal layer, the at least one magnetic varnish layer and the at least one masking varnish layer are applied to the underside of the carrier layer; or
b) the at least one first adhesion-promoter layer, the at least one metal layer and the at least one color layer are applied to the upper side of the carrier layer and the at least one first adhesion-promoter layer, the at least one magnetic varnish layer and the at least one masking varnish layer are applied to the underside of the carrier layer.

44. The method according to claim 43, wherein in the case of structure a) after step i) the steps are carried out in the order v), ii), iii), iv), vi) on the underside of the carrier layer provided in step i), or in the case of structure b) after step i) the steps are carried out in the order v), iii), ii) on the upper side of the carrier layer provided in step i) and the steps are carried out in the order v), iv), vi) on the underside of the carrier layer provided in step i).

45. The method according to claim 41, wherein, in the case of structure a) between steps ii) and iii) the following step is further carried out:
vii) applying at least one replication layer.

46. The method according to claim 45, wherein in the case of structure a) and in step vii) optically variable structures, and/or refractive structures and/or isotropic matte structures and/or anisotropic matte structures, are introduced into the at least one replication layer by means of thermal replication and/or UV replication.

47. The method according to claim 41, wherein, in the case of structure a) between steps iii) and iv) the following step is further carried out:
viii) applying at least one corrosion varnish layer, in order to prevent a direct contact of the at least magnetic varnish layer with the at least one metal layer.

48. (canceled)

49. The method according to claim 41, wherein in the case of structure a) and in particular after step vi) the following step is further performed:
x) applying at least one second adhesion-promoter layer 17 to the upper side of the at least one carrier layer.

50. The method according to claim 41, wherein, in the case of structure a) the following step is further performed:
xi) applying at least one third adhesion-promoter layer to the underside of the at least one carrier layer.

51. The method according to claim 41, wherein, in the case of structure a), the following step is further carried out:
xii) applying at least one further carrier layer to the underside of the at least one carrier layer.

52. The method according to claim 41, wherein, in the case of structure b) between steps v) and iv), the following step is further carried out:
xiii) applying at least one replication layer, with the result that the at least one replication layer is applied to the upper side of the at least one carrier layer between the at least one first adhesion-promoter layer and/or the at least one carrier layer and the at least one metal layer.

53. The method according to claim 52, wherein in the case of structure b) and in step xiii) optically variable structures, and/or refractive structures and/or isotropic matte structures and/or anisotropic matte structures, are introduced into the at least one replication layer by means of thermal replication and/or UV replication.

54. The method according to claim 41, wherein, in the case of structure b) after step ii) and/or after step vi) the following step is further performed:
xiv) applying at least one second adhesion-promoter layer.

55. The method according to claim 41, wherein, in the case of structure a) after step vi) or in the case of structure b) after steps ii) and vi) the following step is further performed:
xv) applying at least one first primer layer to the underside of the carrier layer or the underside of the multilayer body and applying at least one second primer layer to the upper side of the carrier layer or the upper side of the multilayer body, with the result that the at least one first primer view and the at least one second primer layer form the outer layers of the multilayer body.

56. (canceled)

57. The method according to claim 43, wherein, in step ii) the at least one color layer is applied in the decoration.

58. The method according to claim 41, wherein, in step ii) the at least one color layer is applied in a first area and is not applied in a second area.

59. The method according to claim 41, wherein, in step ii) the at least one color layer is designed as an etch resist for structuring the at least one metal layer and/or as an exposure mask for structuring an etch resist.

60. (canceled)

61. The method according to claim 41, wherein the application of the at least one metal layer in step iii) is effected register-accurately or registration-accurately.

62-65. (canceled)

66. The method according to claim 41, wherein, in step iv) the at least one magnetic varnish layer is applied register-accurately or registration-accurately relative to the at least one color layer and/or the at least one metal layer.

67. The method according to claim 41, wherein, in step iv) the at least one magnetic varnish layer is applied in a partial area of the first area and is not applied in a second area, with the result that for an observer viewing the upper side of the multilayer body the at least one magnetic varnish layer is covered by the at least one color layer and/or the at least one metal layer.

68. (canceled)

69. The method according to claim 41, wherein, in step vi) the at least one masking varnish layer is applied registration-accurately or register-accurately relative to the at least one magnetic varnish layer with the result that the at least one masking varnish layer covers the at least one magnetic varnish layer.

70. (canceled)

71. The method according to claim 41, wherein, in the case of structure a) after step iii) and before step iv), the following step is further performed:
xvi) applying at least one photosensitive layer over the whole surface.

72. The method according to claim 71, wherein in structure a) after step xvi) the following step is further performed:
xvii) exposing the at least one photosensitive layer to light from the upper side of the multilayer body, with the result that the at least one colored varnish layer serves as an exposure mask for the at least one photosensitive layer and the at least one photosensitive layer is activated by radiation, with the result that the at least one photosensitive layer becomes soluble in the second areas.

73. The method according to claim 72, wherein in structure a) after step xvii) the following step is further performed:
xviii) structuring the at least one photosensitive layer by means of a solvent, with the result that the at least one photosensitive layer is removed in the second areas and is preserved in the first areas.

74. The method according to claim 73, wherein in structure a) after step xviii) the following step is further performed:
xix) demetallizing the at least one metal layer by means of etching, wherein the at least one photosensitive layer serves as an etch resist and the at least one metal layer is removed in the second areas and is preserved in the first areas.

75. The method according to claim 74, wherein in structure a) after step xix) the following step is further performed:
xx) removing the at least one photosensitive layer.

76. The method according to claim 41, wherein, in structure b) after step ii) the following step is further performed:
xxi) demetallizing the at least one metal layer by means of etching, wherein the at least one color layer serves as an etch resist and the at least one metal layer is removed in the second areas and is preserved in the first areas.
